(19) United States
(12) Patent Application Publication
(10) Pub. No.: US 2026/0025224 A1
(43) Pub. Date: Jan. 22, 2026

(54) INTEGRATED CIRCUIT AND MEMORY SYSTEM INCLUDING ECC CIRCUIT

(71) Applicant: SK hynix Inc., Gyeonggi-do (KR)

(72) Inventors: Mun Seon JANG, Gyeonggi-do (KR); Seong Yoon KANG, Gyeonggi-do (KR); Sang Uhn CHA, Gyeonggi-do (KR); Dong Hee HAN, Gyeonggi-do (KR)

(21) Appl. No.: 19/066,164

(22) Filed: Feb. 28, 2025

Related U.S. Application Data
(60) Provisional application No. 63/672,177, filed on Jul. 16, 2024.

(51) Int. Cl. H04L 1/00

(52) U.S. Cl. CPC H04L 1/0041; H04L 1/0063

(57) ABSTRACT

An integrated circuit includes data terminals 0 to 11; an ECC encoder circuit configured to operate an H matrix on transmission data to be transmitted to the data terminals 0 to 11 to generate a transmission parity code, the transmission parity code corresponding to the transmission data; and an ECC decoder circuit configured to operate the H matrix on reception data and a reception parity code received through the data terminals 0 to 11 to detect and correct an error in the reception data. A data portion of the H matrix is divided into 24 groups, each of the 24 groups includes a group matrix portion and a non-group matrix portion, the group matrix portion is used by k group matrices that circulate in the 24 groups, and each time the k group matrices circulate one round, positions of the k group matrices inserted in groups is shifted.

### CROSS-REFERENCE TO RELATED APPLICATION

This application claims priority under 35 U.S.C. § 119(a) to U.S. Patent Application No. 63/672,177 filed on Jul. 16, 2024, which is incorporated herein by reference in its entirety.

### BACKGROUND

### 1. Technical Field

Embodiments of the present disclosure relate to an integrated circuit and a memory system.

### 2. Related Art

In the early days of the semiconductor memory industry, a plurality of original good dies having no defective memory cells in a memory chip having passed through a semiconductor manufacturing process have been distributed on a wafer. However, as the capacity of a memory gradually increases, it has become difficult to produce a memory having no defective memory cells. At the present time, there is no probability that such a memory device will be manufactured. As one way to overcome such a situation, a method of repairing defective memory cells of a memory device with redundancy memory cells is used.

As another way, an error, which occurs in a memory cell and an error, which occurs when data is transmitted during a read and write process of a memory system, are corrected using an error correction circuit (i.e., ECC engine) that corrects an error in the memory system.

### SUMMARY

In an embodiment of the present disclosure, an integrated circuit may include data terminals 0 to 11; an ECC encoder circuit configured to operate an H matrix on transmission data to be transmitted to the data terminals 0 to 11 to generate a transmission parity code to be transmitted together with the transmission data, the transmission parity code corresponding to the transmission data; and an ECC decoder circuit configured to operate the H matrix on reception data and a reception parity code received through the data terminals 0 to 11 to detect and correct an error in the reception data, wherein a data portion of the H matrix may be divided into 24 groups, each of the 24 groups may include a group matrix portion for distinguishing groups and a non-group matrix portion for distinguishing bits within a corresponding group, the group matrix portion may be used by k group matrices that circulate in the 24 groups, and each time the k group matrices circulate one round, positions of the k group matrices in groups may be shifted, where k is an integer of 2 or more and less than 24.

In an embodiment of the present disclosure, a memory system may include a memory controller and a memory, and the memory controller may include a first ECC encoder circuit configured to operate an H matrix on 272-bit write data to generate a 16-bit write parity code corresponding to the 272-bit write data; a first data transmission circuit configured to transmit the 272-bit write data and the 16-bit write parity code to the memory; a first data reception circuit configured to receive 272-bit read data and a 16-bit read parity code transmitted from the memory; and a first ECC decoder circuit configured to operate the H matrix on the 272-bit read data and the read parity to detect and correct an error in the 272-bit read data, wherein the H matrix has a size of 16×288, a data portion of the H matrix is divided into 20 groups each having a size of 16×12 and four groups each having a size of 16×8, each of 24 groups including the 20 groups and the four groups includes a group matrix portion for distinguishing groups and a non-group matrix portion for distinguishing bits within a corresponding group, the group matrix portion is used by six group matrices that circulate in the 24 groups, and each time the six group matrices circulate one round, positions of the six group matrices inserted in groups are shifted.

In an embodiment of the present disclosure, a memory may include: 0^{th} to third data terminals configured to receive 24-bit data during a write operation, respectively; fourth and fifth data terminals configured to receive 20-bit data and a 4-bit parity code during the write operation, respectively; sixth to ninth data terminals configured to receive 24-bit data during the write operation, respectively; and tenth and eleventh data terminals configured to receive 20-bit data and a 4-bit parity code during the write operation, respectively.

### BRIEF DESCRIPTION OF THE DRAWINGS

FIG. 1 is a diagram illustrating a configuration of a memory system in accordance with an embodiment of the present disclosure.

FIG. 2 is a diagram for describing an H matrix used by ECC circuits shown in FIG. 1, in accordance with an embodiment of the present disclosure.

FIG. 3 is a diagram for describing a process in which each of the ECC encoder circuits shown in FIG. 1 generates a parity code by using the H matrix shown in FIG. 2, in accordance with an embodiment of the present disclosure.

FIG. 4 is a diagram for describing how parity codes are generated by each of the ECC encoder circuits shown in FIG. 1 when data all have a value of 1, in accordance with an embodiment of the present disclosure.

FIG. 5 is a diagram for describing a process in which each of the ECC decoder circuits shown in FIG. 1 generates syndromes by using the H matrix shown in in FIG. 2, in accordance with an embodiment of the present disclosure.

FIG. 6 is a diagram for describing how the syndromes are generated by each of the ECC decoder circuits and how a 1-bit error is corrected when the 1-bit error exists in data input to the ECC decoder circuits shown in FIG. 1, in accordance with an embodiment of the present disclosure.

FIGS. 7 and 8 are diagrams for describing how the syndromes are generated by each of the ECC decoder circuits and how a 2-bit error is processed when the 2-bit error exists in data input to the ECC decoder circuits shown in FIG. 1, in accordance with an embodiment of the present disclosure.

FIG. 9 is a diagram illustrating a configuration of an H matrix for preventing miscorrection and correctly detecting an error, in accordance with an embodiment of the present disclosure.

FIGS. 10A to 10D are diagrams for describing an H matrix that complies with the rules proposed in embodiments of the present disclosure.

FIG. 11 is a diagram for describing a data packet used by the memory system, in accordance with an embodiment of the present disclosure.

FIGS. 12A to 12D are diagrams in which data and a parity code of the H matrix shown in FIGS. 10A to 10D are numbered in consideration of the data packet shown in FIG. 11, in accordance with an embodiment of the present disclosure.

### DETAILED DESCRIPTION

Various embodiments of the present disclosure are directed to providing a technology of detecting a multi-bit error occurring in a memory.

In accordance with embodiments of the present disclosure, a multi-bit error occurring in a memory system can be detected.

Hereafter, embodiments in accordance with the technical spirit of the present disclosure are described with reference to the accompanying drawings.

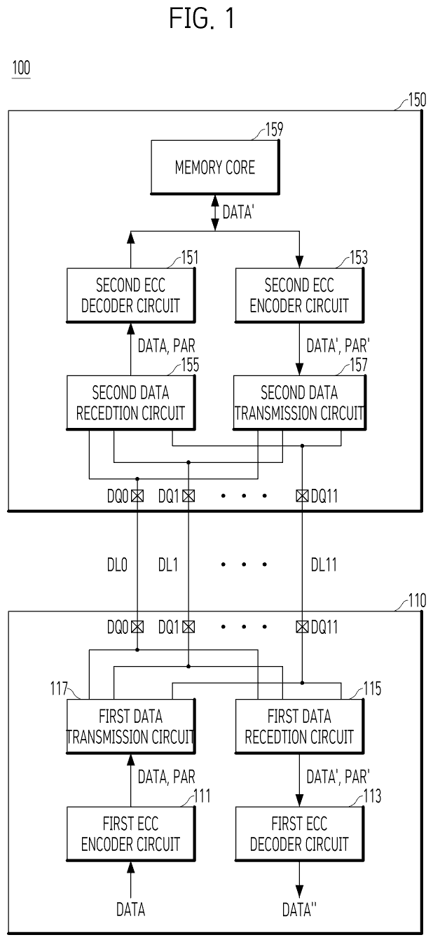

FIG. 1 is a diagram illustrating a configuration of a memory system 100 in accordance with an embodiment of the present disclosure. FIG. 1 illustrates only parts directly related to data transmission and error correction in the memory system 100.

Referring to FIG. 1, the memory system 100 includes a memory controller 110, a memory 150, and data lines DL0 to DL11.

In an embodiment, the memory controller 110 controls operations such as read and write of the memory 150 according to requests from a host. The memory controller 110 includes a first error correction code (ECC) encoder circuit 111, a first ECC decoder circuit 113, a first data reception circuit 115, and a first data transmission circuit 117.

In an embodiment, the first ECC encoder circuit 111 may generate a parity code PAR by using data DATA, that is, write data to be transmitted by the memory controller 110 to the memory 150. That is, the first ECC encoder circuit 111 may encode the data DATA and generate the parity code PAR for detecting and correcting an error in the data DATA. Because only the parity code PAR is generated and no error correction operation is performed during the encoding operation, the data DATA input to the first ECC encoder circuit 111 and data DATA output from the first ECC encoder circuit 111 are the same during the encoding operation. In the following example, the data DATA is 272 bits and the parity code PAR is 16 bits.

In an embodiment, the first data transmission circuit 117 may transmit the data DATA and the parity code PAR generated in the first ECC encoder circuit 111 to the memory 150 through the data terminals DQ0 to DQ11. Because the data DATA and the parity code PAR are transmitted from the memory controller 110 to the memory 150 during a write operation, the first data transmission circuit 117 is used during the write operation. The data DATA and the parity code PAR between the memory controller 110 and the memory 150 are transmitted with a burst length BL of 24. That is, 288-bit information obtained by summing the data DATA and the parity code PAR is transmitted and received by 24 bits per 12 data terminals DQ0 to DQ11 (288=12*24).

In an embodiment, the first data reception circuit 115 may receive data DATA′ and a parity code PAR′ transmitted from the memory 150. Because the data DATA′ and the parity code PAR′ are transmitted from the memory 150 to the memory controller 110 during a read operation, the first data reception circuit 115 is used during the read operation. The first data reception circuit 115 may receive information by 24 bits per the 12 data terminals DQ0 to DQ11.

In an embodiment, the first ECC decoder circuit 113 may detect and correct an error in the data DATA′ received by the first data reception circuit 115, that is, read data, by using the parity code PAR′ received by the first data reception circuit 115. The memory controller 110 may provide the host with data DATA″ processed by the first ECC encoder circuit 111.

In an embodiment, the data lines DL0 to DL11 may connect the data terminals DQ0 to DQ11 of the memory controller 110 and the data terminals DQ0 to DQ11 of the memory 150. During a write operation, 24 bits of information are transmitted from the memory controller 110 to the memory 150 through each of the data lines DL0 to DL11, and during a read operation, 24-bit information is transmitted from the memory 150 to the memory controller 110 through each of the data lines DL0 to DL11.

In an embodiment, the memory 150 may include a second ECC decoder circuit 151, a second ECC encoder circuit 153, a second data reception circuit 155, a second data transmission circuit 157, and a memory core 159.

In an embodiment, the second data reception circuit 155 may receive the data DATA and the parity code PAR transmitted from the memory controller 110. Because the data DATA and the parity code PAR are transmitted from the memory controller 110 to the memory 150 during a write operation, the second data reception circuit 155 is used during the write operation. The second data reception circuit 155 may receive information by 24 bits per the 12 data terminals DQ0 to DQ11.

In an embodiment, the second ECC decoder circuit 151 may use the parity code PAR received by the first data reception circuit 115 to detect and correct an error in the data DATA received by the first data reception circuit 115, that is, write data. Data DATA′ processed by the second ECC decoder circuit 151 is stored in the memory core 159.

In an embodiment, during a write operation, the memory core 159 may receive and store the data DATA′ processed by the second ECC decoder circuit 151. During a read operation, the memory core 159 may transfer the stored data DATA′ to the second ECC encoder circuit 153. The memory core 159 may refer to a place in the memory 150 where data is stored, and include a plurality of memory cells for storing data and circuits for writing data to the plurality of memory cells and reading the data from the plurality of memory cells.

In an embodiment, the second ECC encoder circuit 153 may generate a parity code PAR′ by using the data DATA′ transmitted from the memory core 159, that is, the read data. That is, the second ECC encoder circuit 153 may encode the data DATA′ and generate the parity code PAR′ for correcting an error in the data DATA′. During the encoding operation, because only the parity code PAR′ is generated and no error correction operation is performed, the data DATA′ input to the second ECC encoder circuit 153 and the data DATA′ output from the second ECC encoder circuit 153 are the same during the encoding operation.

In an embodiment, the second data transmission circuit 157 may transmit the data DATA′ and the parity code PAR′ generated by the second ECC encoder circuit 153 to the memory controller 110 through the data terminals DQ0 to DQ11. Because the data DATA′ and the parity code PAR′ are transmitted from the memory 150 to the memory controller 110 during a read operation, the second data transmission circuit 157 is used during the read operation.

Hereinafter, how a data error is handled during write and read operations of the memory system 100 is described.

In an embodiment, during a write operation, the first ECC encoder circuit 111 of the memory controller 110 may generate a parity code PAR for correcting an error in write data DATA, and the write data DATA and the parity code PAR are transmitted from the memory controller 110 to the memory 150. The second ECC decoder circuit 151 of the memory 150 may detect and correct the error in the write data DATA by using the parity code PAR, and data DATA′ processed by the second ECC decoder circuit 151 is written to the memory core 159. That is, during the write operation, an error in the write data DATA, which occurs in the process of transmitting the write data DATA from the memory controller 110 to the memory 150, is detected and corrected by the operations of the first ECC encoder circuit 111 and the second ECC decoder circuit 151.

In an embodiment, during a read operation, the second ECC encoder circuit 153 of the memory 150 may generate a parity code PAR′ for correcting an error in the data DATA′ read from the memory core 159, and the read data DATA′ and the parity code PAR′ are transmitted from the memory 150 to the memory controller 110. The first ECC decoder circuit 113 of the memory controller 110 may detect and correct an error in the data DATA′ by using the parity code PAR′, and the memory controller 110 may provide the host with the data DATA″ processed by the first ECC decoder circuit 113. That is, during the read operation, an error in the read data DATA′, which occurs in the process of transmitting the read data DATA′ from the memory 150 to the memory controller 110, is detected and corrected by the operations of the second ECC encoder circuit 153 and the first ECC decoder circuit 113.

In an embodiment, an error in data transmitted and received between the memory controller 110 and the memory 150 is detected and corrected by the ECC circuits 111, 113, 151, and 153 of the memory controller 110 and the memory 150. In this way, the ECC circuits for detecting and correcting an error in data transmitted and received between two integrated circuits are also referred to as link ECC circuits. Although FIG. 1 illustrates an embodiment in which the ECC circuits 111, 113, 151, and 153 are applied to the memory controller 110 and the memory 150, of course such circuits are also applicable to any two integrated circuits that communicate data (or signals) with each other.

In an embodiment, the ECC decoder circuits 113 and 151 are set to a mode that corrects and senses an error in data, or are set to a mode that only senses an error in data without correcting the error.

The ECC circuits 111, 113, 151, and 153 in FIG. 1 may perform encoding and decoding operations by using an H matrix also called a check matrix, which is described below.

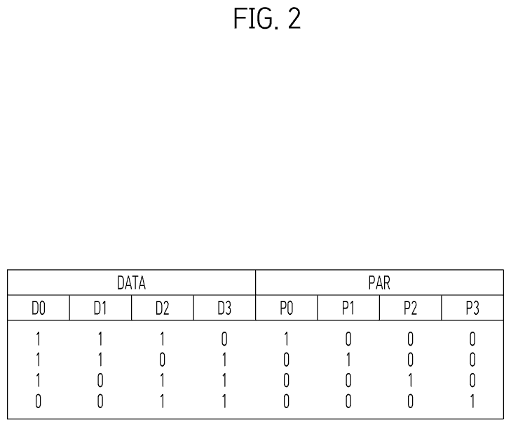

FIG. 2 is a diagram for describing an H matrix used by the ECC circuits 111, 113, 151, and 153 in FIG. 1, in accordance with an embodiment of the present disclosure. For convenience of description, the data DATA is 4 bits D0 to D3 and the parity code PAR is 4 bits P0 to P3.

The data DATA refers to data input to the ECC circuits 111, 113, 151, and 153.

In an embodiment, the H matrix is configured by a matrix of (number of bits of parity code)×(number of bits of data+number of bits of parity code). Because the parity code PAR is 4 bits and the data DATA is 4 bits, the H matrix is configured by a 4×8 matrix. Each component of the H matrix has a value of 1 or 0.

In an embodiment, column vectors of the H matrix correspond to the bits D0 to D3 of the data DATA and the bits P0 to P3 of the parity code PAR. For example, among eight column vectors, four column vectors correspond to the bits D0 to D3 of the data DATA, and four column vectors correspond to the bits P0 to P3 of the parity code PAR. In FIG. 2, D1 corresponds to a column vector with a value of ‘1110’ and P3 corresponds to a column vector with a value of ‘0001’.

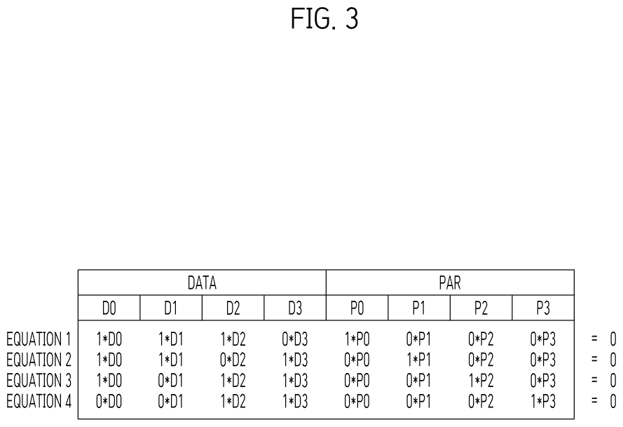

FIG. 3 is a diagram for describing a process in which each of the ECC encoder circuits 111 and 153 shown in FIG. 1 generates the parity code PAR by using the H matrix shown in FIG. 2, in accordance with an embodiment of the present disclosure.

In an embodiment, each of the ECC encoder circuits 111 and 153 multiplies each of the column vectors of the H matrix with a corresponding bit and then generates the parity code PAR so that the sum of rows is 0 (that is, an even number).

That is, the parity code PAR is generated so that all four equations below are satisfied.

$$Equation 1$$

$$1 * D 0 + 1 * D 1 + 1 * D 2 + 0 * D 3 + 1 * P 0 + 0 * P 1 + 0 * P 2 + 0 * P 3 = 0$$

$$Equation 2$$

$$1 * D 0 + 1 * D 1 + 0 * D 2 + 1 * D 3 + 0 * P 0 + 1 * P 1 + 0 * P 2 + 0 * P 3 = 0$$

$$Equation 3$$

$$1 * D 0 + 0 * D 1 + 1 * D 2 + 1 * D 3 + 0 * P 0 + 0 * P 1 + 1 * P 2 + 0 * P 3 = 0$$

$$Equation 4$$

$$0 * D 0 + 0 * D 1 + 1 * D 2 + 1 * D 3 + 0 * P 0 + 0 * P 1 + 0 * P 2 + 1 * P 3 = 0$$

An addition in the above equations and the following description means an exclusive OR. Accordingly, the addition is performed in such a way that when the number of 1's is even, the result of the addition is 0, and when the number of 1's is odd, the result is 1. For example, 1+1+0+1 is 1 and 0+1+1+0 is 0.

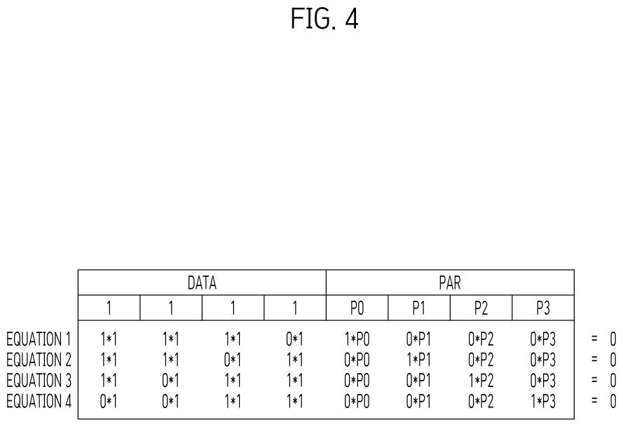

FIG. 4 is a diagram for describing how the parity codes P0 to P3 are generated by each of the ECC encoder circuits 111 and 153 shown in FIG. 1 when the data D0 to D3 all have a value of 1, in accordance with an embodiment of the present disclosure.

Referring to FIG. 4, values of the error correction codes P0 to P3 are obtained by putting the value of 1 into the data D0 to D3 of Equation 1 to Equation 4 above and solving these Equations.

In this case, the error correction codes P0 to P3 are generated as (1, 1, 1, 0).

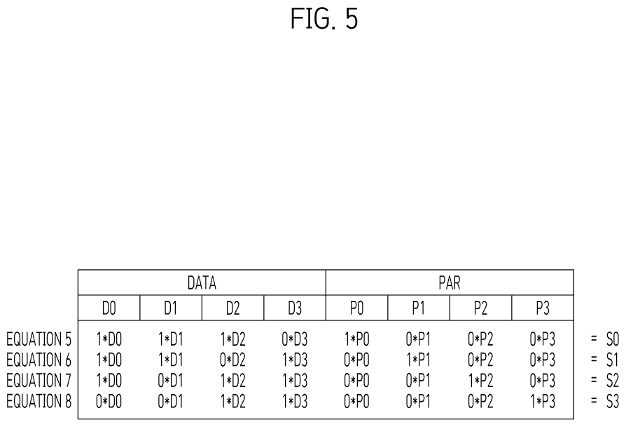

FIG. 5 is a diagram for describing a process in which each of the ECC decoder circuits 113 and 151 shown in FIG. 1 generates syndromes S0 to S3 by using the H matrix in FIG. 2, in accordance with an embodiment of the present disclosure.

In an embodiment, each of the ECC decoder circuits 113 and 151 generates the syndromes S0 to S3 by putting the data DATA and the parity code PAR input to them into the H matrix and operating the H matrix. Each of the ECC decoder circuits 113 and 151 generates the syndromes S0 to S3 by multiplying each of the column vectors of the H matrix with a corresponding bit and then calculating the sum of rows.

That is, the syndromes S0 to S3 are generated using the following four Equations. The syndromes S0 to S3 are used to detect and correct an error.

$$Equation 5$$

$$1 * D 0 + 1 * D 1 + 1 * D 2 + 0 * D 3 + 1 * P 0 + 0 * P 1 + 0 * P 2 + 0 * P 3 = S 0$$

$$Equation 6$$

$$1 * D 0 + 1 * D 1 + 0 * D 2 + 1 * D 3 + 0 * P 0 + 1 * P 1 + 0 * P 2 + 0 * P 3 = S 1$$

$$Equation 7$$

$$1 * D 0 + 0 * D 1 + 1 * D 2 + 1 * D 3 + 0 * P 0 + 0 * P 1 + 1 * P 2 + 0 * P 3 = S 2$$

$$Equation 8$$

$$0 * D 0 + 0 * D 1 + 1 * D 2 + 1 * D 3 + 0 * P 0 + 0 * P 1 + 0 * P 2 + 1 * P 3 = S 3$$

When there is no error in the data DATA and the parity code PAR input to each of the ECC decoder circuits 113 and 151, the syndromes S0 to S3 generated by each of the ECC decoder circuits 113 and 151 all have a value of 0.

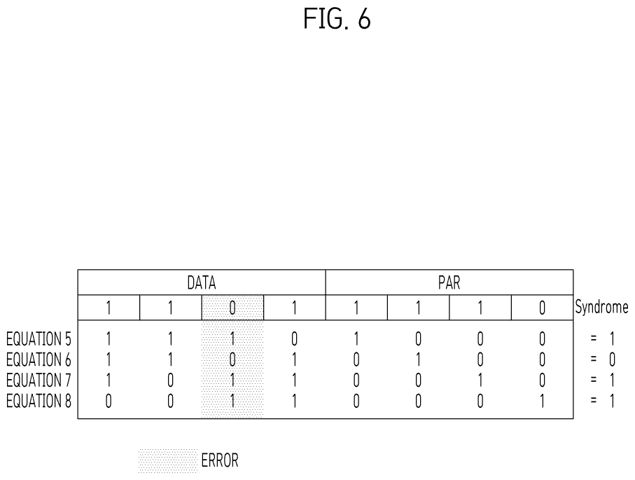

FIG. 6 is a diagram for describing how the syndromes S0 to S3 are generated by each of the ECC decoder circuits 113 and 151 and how a 1-bit error is corrected when the 1-bit error exists in data DATA input to the ECC decoder circuits 113 and 151 shown in FIG. 1, in accordance with an embodiment of the present disclosure. In FIG. 6, it is illustrated that an error has occurred after the data D0 to D3 all having a value of 1 as in the example of FIG. 4 are generated and the parity code PAR of (1, 1, 1, 0) is generated using the data D0 to D3.

Referring to FIG. 6, it can be seen that an error exists in which 1 bit D2 of the data DATA is changed from 1 to 0. When the data D0 to D3 and the parity codes P0 to P3 are put into Equation 5 to Equation 8 above and calculated, the syndromes S0 to S3 are generated as (1, 0, 1, 1).

In an embodiment, when the values of the syndromes S0 to S3 are not (0, 0, 0, 0), it means that an error exists, and the values of the syndromes S0 to S3 indicate a bit where the error exists. That is, it indicates that an error exists in a bit corresponding to a column vector equal to the values of the syndromes S0 to S3. Because the values of the syndromes S0 to S3 are (1, 0, 1, 1), it indicates that an error exists in the bit D2 of the data DATA whose column vector value is (1, 0, 1, 1). In this case, the ECC decoder circuits 113 and 151 correct the error by inverting the bit D2.

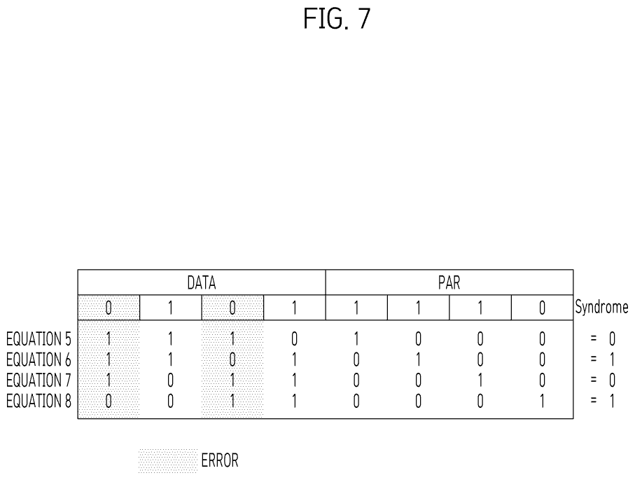

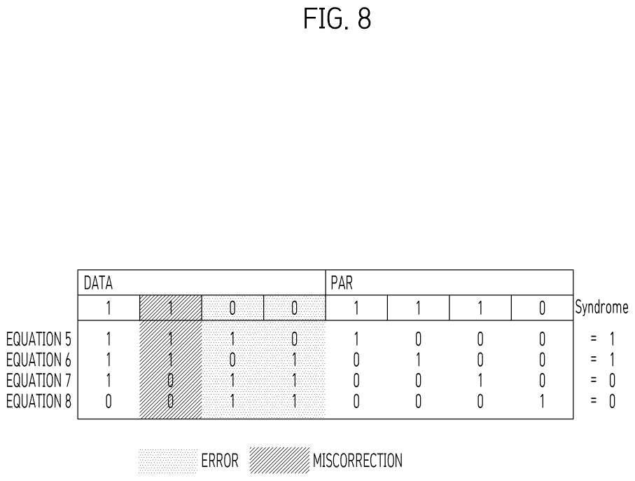

FIGS. 7 and 8 are diagrams for describing how the syndromes S0 to S3 are generated by each of the ECC decoder circuits 113 and 151 and how a 2-bit error is processed when the 2-bit error exists in the data DATA input to the ECC decoder circuits 113 and 151 shown in FIG. 1, in accordance with an embodiment of the present disclosure.

Referring to FIG. 7, an error exists in which 2 bits D0 and D2 of the data DATA are changed from 1 to 0. When the data D0 to D3 and the parity codes P0 to P3 are put into Equation 5 to Equation 8 above and are calculated, the syndromes S0 to S3 are generated as (0, 1, 0, 1). Accordingly, the syndromes S0 to S3 are generated with the same value as the sum of the column vectors of the bits D0 and D2 in which the error exists. That is, the sum of (1, 1, 1, 0) being the column vector of the bit D0 and (1, 0, 1, 1) being the column vector of the bit D2 and the values (0, 1, 0, 1) of the syndromes S0 to S3 are the same.

When the values of the syndromes S0 to S3 are not (0, 0, 0, 0), it means that an error exists. However, in the H matrix, there is no column vector with the same value as (0, 1, 0, 1) being the values of the syndromes S0 to S3, which means that an error exists but is not correctable. That is, in the case of FIG. 7, an error is detectable but is not correctable.

Referring to FIG. 8, an error exists in which 2 bits D2 and D3 of the data DATA are changed from 1 to 0. In this case, the syndromes S0 to S3 are generated as (1, 1, 0, 0) being the sum of the column vector (1, 0, 1, 1) of the bit D2 and the column vector (0, 1, 1, 1) of the bit D3.

When the values of the syndromes S0 to S3 are not (0, 0, 0, 0), it means that an error exists. In the H matrix, because the column vector (1, 1, 0, 0) of the bit D1 exists as a column vector having the same value as (1, 1, 0, 0) being the values of the syndromes S0 to S3, the ECC decoder circuits 113 and 151 determine that an error exists in the bit D1 and correct the error by inverting the bit D1. Portions where an error has actually occurred are the bits D2 and D3, but the error in the bits D2 and D3 remains, and the bit D1 having no error is corrected, which causes miscorrection in which an error increases.

The reason why the miscorrection illustrated in FIG. 8 occurs is because errors are not distinguishable by only the values of the syndromes S0 to S3. For example, as illustrated in FIG. 8, when an error occurs in the bits D2 and D3 and when an error occurs in the bit D1, because the values of the syndromes S0 to S3 are generated the same, the ECC decoder circuits 113 and 151 determine that an error has occurred in the bit D1 and make miscorrection. Hereinafter, the configuration of the H matrix for preventing such miscorrection is described.

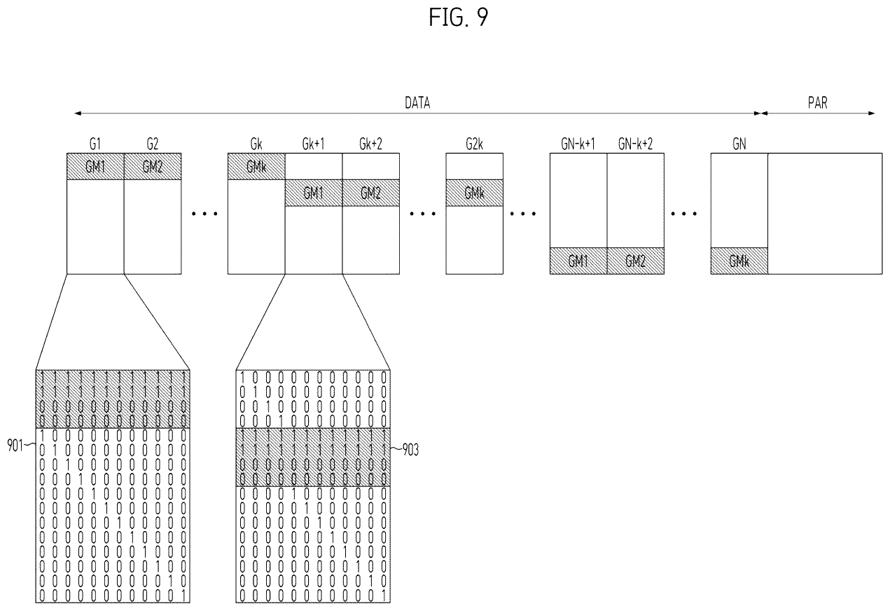

FIG. 9 is a diagram illustrating the configuration of the H matrix for preventing miscorrection and correctly detecting an error, in accordance with an embodiment of the present disclosure.

Referring to FIG. 9, a data portion DATA of the H matrix is divided into N groups G1 to GN. Each of the groups G1 to GN includes a group matrix portion for distinguishing the groups and a non-group matrix portion for distinguishing bits within the group. In the groups G1 to GN of FIG. 9, a colored portion corresponds to the group matrix portion, and an uncolored portion corresponds to the non-group matrix portion.

In an embodiment, in the N groups G1 to GN, the group matrix portion is used by k group matrices GM1 to GMk that circulate. Each time the k group matrices GM1 to GMk circulate one round, insertion positions of the group matrices GM1 to GMk in the groups G1 to GN are changed (i.e., shifted). For example, in the groups G1 to Gk, the group matrices GM1 to GMk are inserted into upper rows, but in the groups Gk+1 to G2k, the group matrices GM1 to GMk are inserted into rows lower than in the groups G1 to Gk. In the groups GN−k+1 to GN, the group matrices GM1 to GMk are inserted into the lowest rows. In each of the group matrices GM1 to GMk, all column vectors within the same group have the same form. FIG. 9 illustrates an example 901 of the group G1 and an example 903 of the group Gk+1. It can be seen that the group matrix of the group G1 has a form in which column vectors of all columns are (1, 1, 0, 0) and the group matrix of the group Gk+1 also has a form in which column vectors of all columns are also (1, 1, 0, 0). However, in the group G1, the group matrices are inserted into the uppermost four rows, but in the group Gk+1, the group matrices are inserted into fifth to eighth rows. That is, the group matrix GM1 inserted into the group G1 and the group matrix GM1 inserted into the group Gk+1 are the same as each other, but the insertion positions thereof are different from each other.

In an embodiment, the non-group matrix portion of the groups G1 to GN has a form in which the weights of column vectors of all columns (the number of is in a column) are 1, like an identity matrix. Referring to the example 901 of the group G1 and the example 903 of the group Gk+1 in FIG. 9, it can be seen that the non-group matrix of the group G1 has a form in which the weights of column vectors of all columns are 1 and the non-group matrix of the group Gk+1 also has a form in which the weights of column vectors of all columns are 1.

In an embodiment, the parity code portion PAR of the H matrix has a form in which the weights of column vectors of all columns are 1, like the unit matrix.

When the H matrix is configured to comply with the rules described above, all column vectors in the data portion DATA and the parity code portion PAR of the H matrix are linearly independent. Accordingly, when the ECC circuits 111, 113, 151, and 153 use such an H matrix, the ECC decoder circuits 113 and 151 have a single error correction (SEC) capability that can correct any 1-bit error. The ECC decoder circuits 113 and 151 also have a SEC capability, a double error detection (DED) capability, and any burst n-bit error detection capability. Here, n may mean a size of a group with a large size among groups.

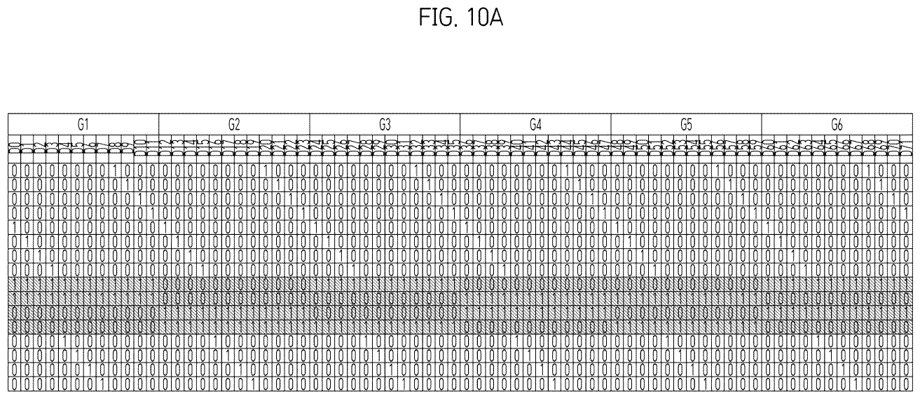

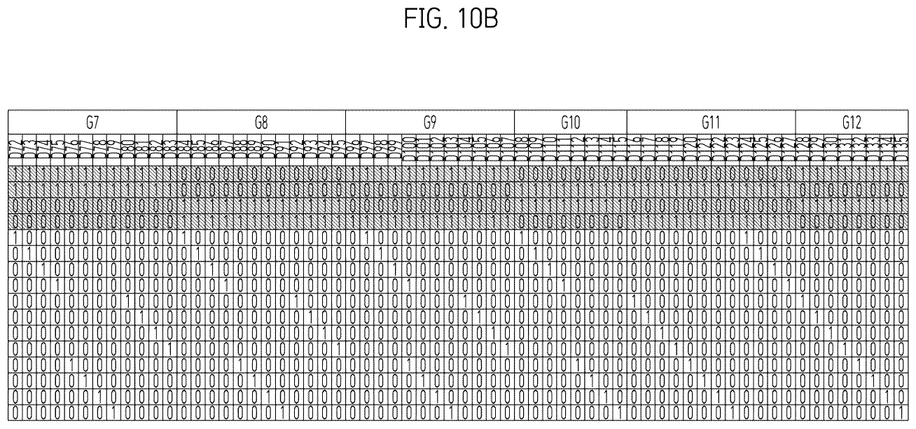

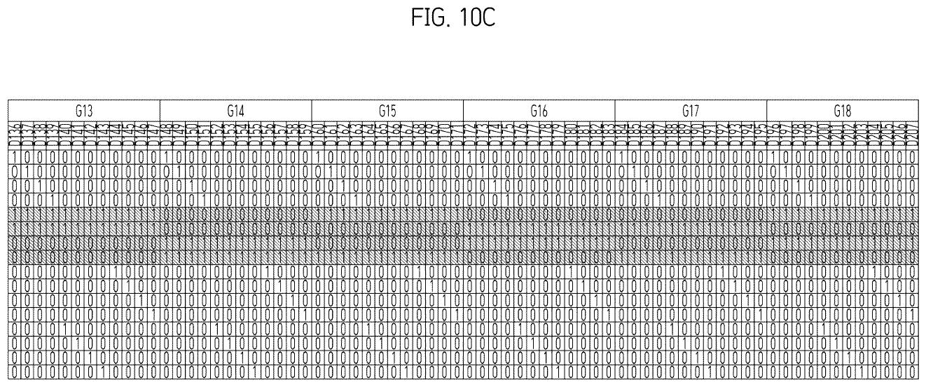

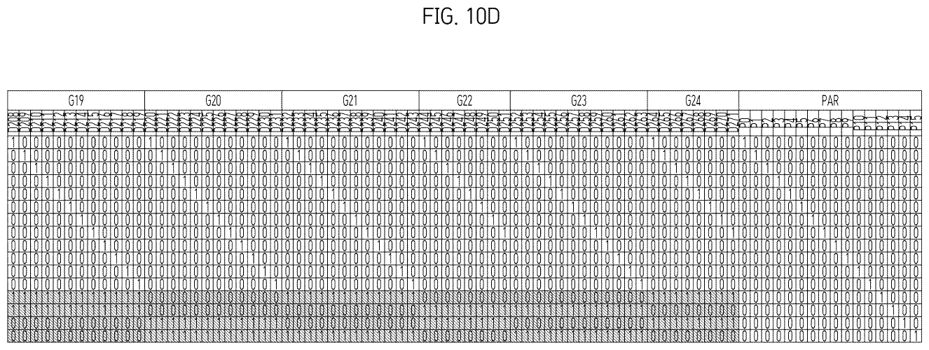

FIGS. 10A to 10D are diagrams for describing an H matrix that complies with the rules proposed in embodiments of the present disclosure.

FIGS. 10A to 10D illustrate an example in which the number of bits of data DATA is 272 bits (D0 to D271), and the parity bit PAR is 16 bits P0 to P15. Therefore, the H matrix has a size of 16×288. In addition, FIGS. 10A to 10D illustrate an example in which the data (D0 to D271) portion of the H matrix is divided into 24 groups G1 to G24. FIGS. 10A to 10D illustrate an example in which the 24 groups G1 to G24 have two sizes, with the groups G1 to G9, G11, G13 to G21, and G23 having a size of 12 bits and groups G10, G12, G22, and G24 having a size of 8 bits.

Referring to FIGS. 10A to 10D, six group matrices with column vector values of (1, 1, 0, 0), (0, 0, 1, 1), (1, 0, 0, 1), (0, 1, 1, 0), (0, 1, 0, 1), and (1, 0, 1, 0) are used repeatedly and each time one round is repeated, the insertion positions of the group matrices in the groups G1 to G24 are changed. For example, a group matrix with the column vector value of (1, 1, 0, 0) is inserted into ninth to twelfth rows in the group G1, a group matrix with the column vector value of (1, 1, 0, 0) is inserted into first to fourth rows in the group G7, and a group matrix with the column vector value of (1, 1, 0, 0) is inserted into fifth to eighth rows in the group G13.

Referring to FIGS. 10A to 10D, non-group matrices of the groups G1 to G24 each have a form in which the weights of column vectors of all columns are 1. Likewise, the parity code PAR portion of the H matrix also has a form in which the weights of column vectors of all columns are 1.

In an embodiment, when the H matrix as illustrated in FIGS. 10A to 10D is used, any bit among the 272-bit data is correctable when a 1-bit error occurs. This is possible because all bits of the H matrix are linearly independent.

In addition, all errors occurring in data of any consecutive 12 bits (maximum size of groups) on the H matrix can be detected without miscorrection. For example, even though an error of 1 to 12 bits occurs in the data D0 to D11, the error can be detected. Even though an error of 1 to 12 bits occurs in the data D5 to D16, the error can be detected. Even though an error of 1 to 12 bits occurs in the data D78 to D89, the error can be detected.

When the consecutive 12-bit data D0 to D11 based on the H matrix are all errors, syndromes S0 to S15 are generated as a value obtained by adding up all column vectors of the data D0 to D11 of the H matrix. This value is (1, 1, 1, 1, 1, 1, 1, 1, 0, 0, 0, 0, 1, 1, 1, 1), and because no column vector identical to this exists in the H matrix, no miscorrection occurs. Because the values of the syndromes S0 to S15 are not all 0, an error exists (i.e., the error can be detected).

When three bits D5, D13, and D15 are errors in consecutive 12-bit data D5 to D16 based on the H matrix, the syndromes S0 to S15 are generated by adding up all column vectors (0, 0, 0, 0, 0, 0, 0, 0, 1, 1, 0, 0, 0, 1, 0, 0), (0, 0, 0, 0, 0, 1, 0, 0, 0, 0, 1, 1, 0, 0, 0, 0), and (0, 0, 0, 0, 0, 0, 0, 1, 0, 0, 1, 1, 0, 0, 0, 0) of the data D5, D13, and D15 of the H matrix. This value is (0, 0, 0, 0, 0, 1, 0, 1, 1, 1, 0, 0, 0, 1, 0, 0), and because no column vector identical to this exists in the H matrix, no miscorrection occurs. Because the values of the syndromes S0 to S15 are not all 0, an error exists (i.e., the error can be detected).

No matter which case is calculated, an error can be detected without miscorrection no matter how many errors occur in any consecutive 12-bit data.

The numbers attached to the data in FIGS. 10A to 10D are used to distinguish each other. For example, D232 and D233 are used to indicate that two bits are different bits.

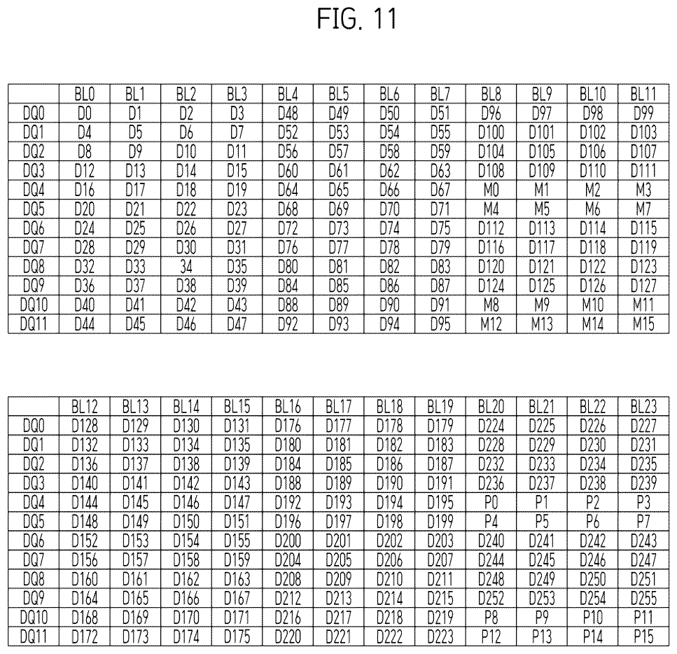

FIG. 11 is a diagram for describing a data packet used by the memory system 100, in accordance with an embodiment of the present disclosure.

In an embodiment, DQ0 to DQ11 represent 12 data terminals DQ0 to DQ11 of the memory controller 110 and the memory 150, and BL0 to BL23 represent 24 consecutive data inputted and outputted to the data terminals DQ0 to DQ11. That is, when data is output to the data terminal DQ0, the data is output in the order of BL0, BL1, and BL2 to BL23 of DQ0 in FIG. 11, that is, in the order of DO, D1, D2, D3, D48, D49 . . . D226, and D227.

The data is numbered by 8 BLs in consideration of the unit in which data is processed in the memory system 100. For example, the data D0 to D95 from BL0 to BL7 of the data terminals DQ0 to DQ11 are sequentially numbered, and the subsequent numbers 96 to 175 are numbered for BL8 to BL15. This is merely convenient numbering, and the numbering of the data has no special meaning.

The 272-bit data includes 256-bit normal data D0 to D255 and 16-bit metadata M0 to M15 and the parity code P0 to P15 is 16 bits.

The 16-bit metadata M0 to M15 is divided in half, 8 bits M0 to M7 are distributed to the data terminals DQ0 to DQ5, and 8 bits M8 to M15 are distributed to DQ6 to DQ11. In addition, the 16-bit parity code P0 to P15 is divided in half, 8 bits P0 to P7 are distributed to the data terminals DQ0 to DQ5, and 8 bits P8 to P15 are distributed to the data terminals DQ6 to DQ11. This is because, depending on the memory system, the data terminals DQ0 to DQ11 are divided in half and processed as separate channels. That is, the data terminals DQ0 to DQ5 are divided into sub-channel 1 and the data terminals DQ6 to DQ11 are divided into sub-channel 2.

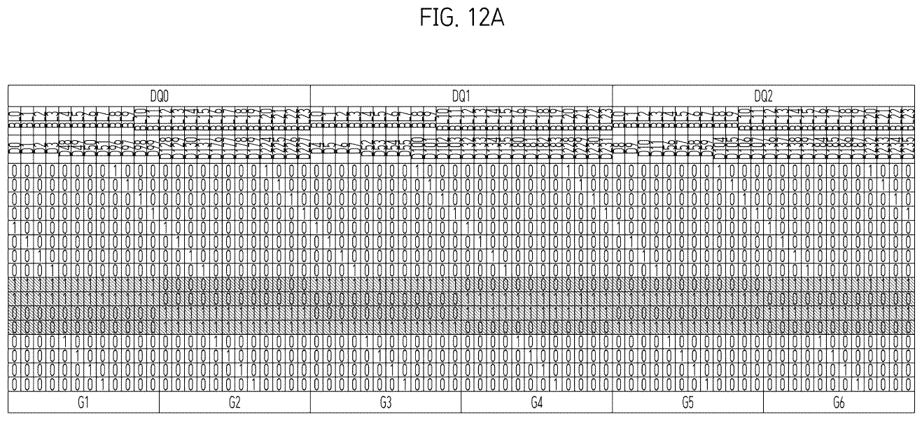

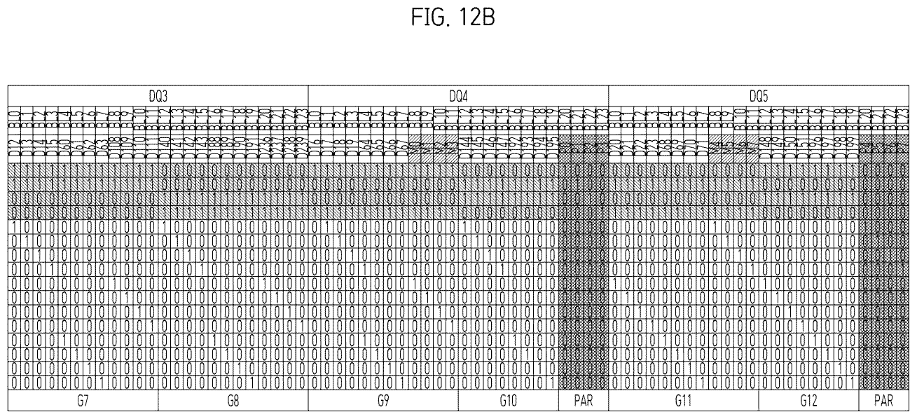

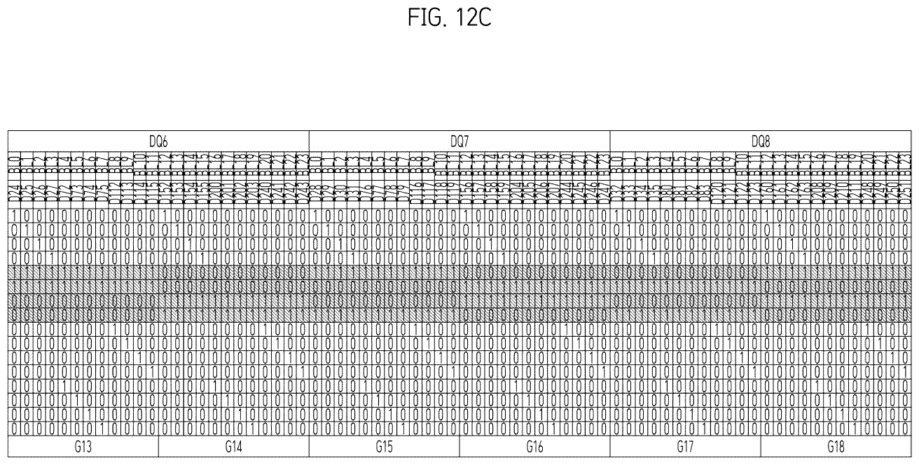

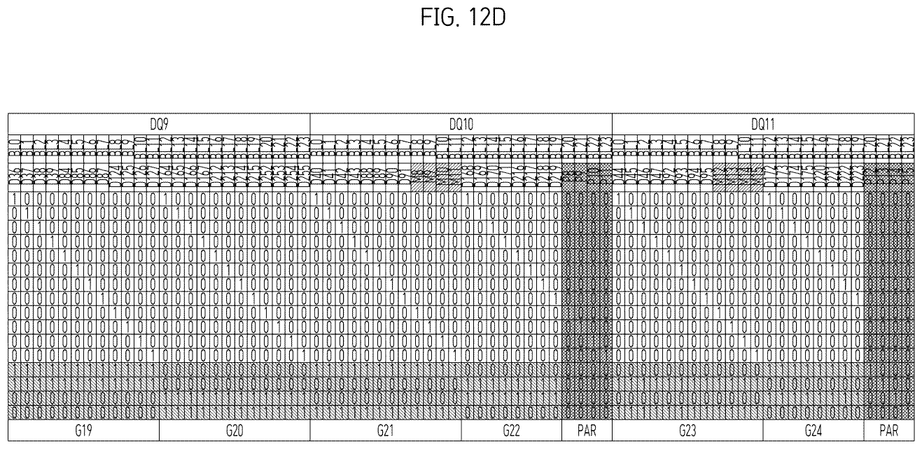

FIGS. 12A to 12D are diagrams in which the data and the parity code of the H matrix shown in FIGS. 10A to 10D are numbered in consideration of the data packet in FIG. 11, in accordance with an embodiment of the present disclosure.

Basically, the H matrix of FIGS. 12A to 12D and the H matrix of FIGS. 10A to 10D are the same, and there is a difference in that the data of the groups G1 to G24 are numbered in consideration of FIG. 11. In addition, because the parity code PAR is transmitted and received to the data pads DQ10 and DQ11, the parity code PAR of the H matrix is illustrated at the locations of the data pads DQ10 and DQ11.

It is the same as described above that detection of all errors occurring on any consecutive 12-bit data on the H matrix of FIGS. 12A to 12D is possible. For example, detection of all errors occurring on consecutive 12-bit data D0, D1, D2, D3, D48, D49, D50, D51, D96, D97, D98, D99 on the H matrix is possible.

Although embodiments according to the technical scope of the present disclosure have been described above with reference to the accompanying drawings, this is only for describing the embodiments according to the concept of the present disclosure, and the present disclosure is not limited to the above embodiments. Various types of substitutions, modifications, and changes for the embodiments may be made by those skilled in the art, to which the present disclosure pertains, without departing from the technical scope of the present disclosure defined in the following claims, and it should be construed that these substitutions, modifications, and changes belong to the scope of the present disclosure. Furthermore, the embodiments may be combined to form additional embodiments.

What is claimed is:

1. An integrated circuit comprising:
data terminals 0 to 11;
an ECC encoder circuit configured to operate an H matrix on transmission data to be transmitted to the data terminals 0 to 11 to generate a transmission parity code to be transmitted together with the transmission data, the transmission parity code corresponding to the transmission data; and
an ECC decoder circuit configured to operate the H matrix on reception data and a reception parity code received through the data terminals 0 to 11 to detect and correct an error in the reception data,
wherein a data portion of the H matrix is divided into 24 groups,
each of the 24 groups comprises a group matrix portion for distinguishing groups and a non-group matrix portion for distinguishing bits within a corresponding group,
the group matrix portion is used by k group matrices that circulate in the 24 groups, and each time the k group matrices circulate one round, positions of the k group matrices inserted in groups are shifted, where k is an integer of 2 or more and less than 24.

2. The integrated circuit of claim 1, wherein each of the data terminals 0 to 11 is configured to transmit and receive data corresponding to two groups among the 24 groups.

3. The integrated circuit of claim 2, wherein each of four data terminals among the data terminals 0 to 11 is configured to further transmit and receive the transmission parity code and the reception parity code by dividing the transmission parity code and the reception parity code by ¼.

4. The integrated circuit of claim 1, wherein the non-group matrix portion of each of the 24 groups has a form in which weights of all column vectors are 1.

5. The integrated circuit of claim 4, wherein in the group matrix portion of each of the 24 groups, all column vectors within a same group have a same form.

6. The integrated circuit of claim 5, wherein a parity code portion of the H matrix has a form in which weights of all column vectors are 1.

7. The integrated circuit of claim 6, wherein all column vectors of the H matrix are linearly independent.

8. The integrated circuit of claim 6, wherein the ECC decoder circuit is able to correct a 1-bit error in the reception data.

9. The integrated circuit of claim 6, wherein the ECC decoder circuit is able to detect up to X errors within consecutive X bits of the reception data, where X is a maximum column size of the 24 groups.

10. The integrated circuit of claim 1, wherein the shift in the positions of the k group matrices indicates a shift of a row where the k group matrices are inserted.

11. The integrated circuit of claim 3, wherein transmission and reception operations are performed with a burst length of 24 through the data terminals 0 to 11.

12. The integrated circuit of claim 11, wherein, when a number of bits of the transmission data and a number of bits of the reception data are each 272 bits:
the number of bits of the transmission parity code and the number of bits of the reception parity code are each 16 bits;
the H matrix has a size of 16×288;
20 groups among the 24 groups each have a size of 16×12; and four groups other than the 20 groups, among the 24 groups each have a size of 16×8.

13. The integrated circuit of claim 12,
wherein each of the data terminal 4, the data terminal 5, the data terminal 10, and the data terminal 11 is configured to transmit and receive 20-bit data and a 4-bit parity code, and
wherein each of data terminals other than the data terminal 4, the data terminal 5, the data terminal 10, and the data terminal 11, among the data terminals 0 to 11 is configured to transmit and receive 24-bit data.

14. The integrated circuit of claim 13,
wherein the 20-bit data transmitted and received through each of the data terminal 4, the data terminal 5, the data terminal 10, and the data terminal 11 comprises 16-bit normal data and 4-bit meta data, and
wherein the 24-bit data transmitted and received through each of the data terminals other than the data terminal 4, the data terminal 5, the data terminal 10, and the data terminal 11, among the data terminals 0 to 11 comprises 24-bit normal data.

15. The integrated circuit of claim 1, wherein the k is 6.

16. A memory system comprising a memory controller and a memory, wherein the memory controller comprises:
a first ECC encoder circuit configured to operate an H matrix on 272-bit write data to generate a 16-bit write parity code corresponding to the 272-bit write data;
a first data transmission circuit configured to transmit the 272-bit write data and the 16-bit write parity code to the memory;
a first data reception circuit configured to receive 272-bit read data and a 16-bit read parity code transmitted from the memory; and
a first ECC decoder circuit configured to operate the H matrix on the 272-bit read data and the 16-bit read parity code to detect and correct an error in the 272-bit read data,
wherein the H matrix has a size of 16×288,
a data portion of the H matrix is divided into 20 groups each having a size of 16×12 and four groups each having a size of 16×8,
each of 24 groups including the 20 groups and the four groups comprises a group matrix portion for distinguishing groups and a non-group matrix portion for distinguishing bits within a corresponding group,
the group matrix portion is used by six group matrices that circulate in the 24 groups, and each time the six group matrices circulate one round, positions of the six group matrices inserted in groups are shifted.

17. The memory system of claim 16, wherein the memory comprises:
a second data reception circuit configured to receive the 272-bit write data and the 16-bit write parity code transmitted from the memory controller;
a second ECC decoder circuit configured to operate the H matrix on the 272-bit write data and the 16-bit write parity code received through the second data reception circuit to detect and correct an error in the 272-bit write data,
a memory core configured to store the 272-bit write data processed by the second ECC decoder circuit, and provide the stored data as the 272-bit read data;
a second ECC encoder circuit configured to operate the H matrix on the 272-bit read data to generate the 16-bit read parity code; and
a second data transmission circuit configured to transmit the 272-bit read data and the 16-bit read parity code to the memory controller.

18. The memory system of claim 17, further comprising:
data lines 0 to 11 configured to connect the memory controller and the memory.

19. The memory system of claim 18, wherein each of the data lines 0 to 11 is configured to transmit and receive data corresponding two groups among the 24 groups.

20. The memory system of claim 19, wherein each of four data lines among the data lines 0 to 11 is configured to further transmit and receive the 16-bit read parity code and the 16-bit write parity code by 4 bits.

21. The memory system of claim 20,
wherein each of the data line 4, the data line 5, the data line 10, and the data line 11 is configured to transmit and receive 20-bit data and a 4-bit parity code, and
wherein each of data lines other than the data line 4, the data line 5, the data line 10, and the data line 11, among the data lines 0 to 11 is configured to transmit and receive 24-bit data.

22. The memory system of claim 21,
wherein the 20-bit data transmitted and received through each of the data line 4, the data line 5, the data line 10, and the data line 11 comprises 16-bit normal data and 4-bit meta data, and
wherein the 24-bit data transmitted and received through each of the data lines other than the data line 4, the data line 5, the data line 10, and the data line 11, among the data lines 0 to 11 comprises 24-bit normal data.

23. The memory system of claim 17, wherein the non-group matrix portion of each of the 24 groups has a form in which weights of all column vectors are 1.

24. The memory system of claim 23, wherein in the group matrix portion of each of the 24 groups, all column vectors within a same group have a same form.

25. The memory system of claim 24, wherein all column vectors of the H matrix are linearly independent.

26. The memory system of claim 16, wherein the shift in the positions of the six group matrices indicates a shift in a row where the six group matrices are inserted.

27. A memory comprising:
0^{th} to third data terminals configured to receive 24-bit data during a write operation, respectively;
fourth and fifth data terminals configured to receive 20-bit data and a 4-bit parity code during the write operation, respectively;
sixth to ninth data terminals configured to receive 24-bit data during the write operation, respectively; and
tenth and eleventh data terminals configured to receive 20-bit data and a 4-bit parity code during the write operation, respectively.

28. The memory of claim 27, wherein, during the write operation, the 20-bit data received through each of the fourth and fifth data terminals and the tenth and eleventh data terminals comprises 16-bit normal data and 4-bit meta data.

29. The memory of claim 28, wherein, during the write operation, each of the fourth and fifth data terminals and the tenth and eleventh data terminals is configured to receive the 20-bit data and the 4-bit parity code in an order of 8-bit normal data, 4-bit meta data, 8-bit normal data, and the 4-bit parity code.
